(19) United States
(12) Patent Application Publication
(10) Pub. No.: US 2012/0153853 A1
(43) Pub. Date: Jun. 21, 2012

(54) BACKLIGHT UNIT

(76) Inventors: BYOUNG DAE YE, Yongin-si (KR); Sang-Chul Byun, Anyang-si (KR); Jung-Hyun Yang, Seoul (KR)

(21) Appl. No.: 13/172,983

(22) Filed: Jun. 30, 2011

(30) Foreign Application Priority Data
Dec. 15, 2010 (KR) 10-2010-0128415

(51) Int. Cl. H05B 37/00

(52) U.S. Cl. 315/193

(57) ABSTRACT

A backlight unit includes a driving circuit outputting a driving voltage, light source strings, a first feedback circuit, a first current control circuit, a second feedback circuit, and a second current control circuit. Each light source string includes light sources and receives the driving voltage to generate light. The first feedback circuit outputs a first control signal based on a measured current at input terminals of the light source strings. The first current control circuit receives the driving voltage and controls a strength of the current input at the input terminals based on the first control signal. The second feedback circuit outputs a second control signal based on a measured current at each output terminal of the light source strings. The second current control circuit controls a strength of a current output at each output terminal of the light source strings.

### CROSS-REFERENCE TO RELATED APPLICATION

This application claims priority under 35 U.S.C. §119 to Korean Patent Application No. 10-2010-0128415 filed on Dec. 15, 2010, the disclosure of which is incorporated by reference herein in its entirety.

### BACKGROUND

1. Technical Field

The present invention relates to a backlight unit. More particularly, the present invention relates to a backlight unit capable of effectively detecting the malfunctioning of light sources.

2. Discussion of the Related Art

A liquid crystal display (LCD) includes an LCD panel that displays an image and a backlight unit disposed below the LCD panel that supplies light to the LCD panel. Recently, light emitting diodes have been used as a light source for the backlight unit rather than a cold cathode fluorescent lamp, since use of the light emitting diodes results in low power consumption and improved color reproduction.

When light emitting diodes are used as the light source for the backlight unit, the backlight unit includes a plurality of light emitting strings connected in parallel to each other. Each light emitting string includes a plurality of light emitting diodes connected to each other in series. However, the use of light emitting strings including light emitting diodes may result in a short circuit or an open circuit.

### SUMMARY

Exemplary embodiments of the present invention provide a backlight unit capable of effectively detecting the malfunctioning of light sources.

According to an exemplary embodiment of the present invention, a backlight unit includes a driving circuit, a plurality of light source strings having a plurality of input terminals, a first feedback circuit, a first current control circuit, a second feedback circuit, and a second current control circuit. The driving circuit is configured to output a driving voltage. Each of the plurality of light source strings includes a plurality of light sources and is configured to receive the driving voltage through one of the input terminals. The first feedback circuit is disposed between the driving circuit and the input terminals of the light source strings, and is configured to output a plurality of first control signals based on a plurality of first currents measured at each of the input terminals. The first current control circuit is disposed between the driving circuit and the first feedback circuit, and is configured to receive the driving voltage and control a strength of each of the plurality of first currents at each of the input terminals based on the plurality of first control signals. The second feedback circuit is connected to each of a plurality of output terminals of the light source strings, and is configured to output a plurality of second control signals based on a plurality of second currents measured at each of the output terminals. The second current control circuit is disposed between the second feedback circuit and the output terminals of the light source strings, and is configured to control a strength of each of the plurality of second currents at each of the output terminals based on the plurality of second control signals.

According to an exemplary embodiment of the present invention, a backlight unit includes a driving circuit, a plurality of light source strings having a plurality of input terminals, a first feedback circuit, a first current control circuit, a second feedback circuit, and a second current control circuit. The driving circuit is configured to output a driving voltage. Each of the plurality of light source strings includes a plurality of light sources and is configured to receive the driving voltage through one of the input terminals. The first feedback circuit is disposed between the driving circuit and the input terminals of the light source strings, and is configured to output a first control signal based on a total current measured at the input terminals. The first current control circuit is disposed between the driving circuit and the first feedback circuit, and is configured to receive the driving voltage and control a strength of the total current at the input terminals based on the first control signal. The second feedback circuit is connected to each of a plurality of output terminals of the light source strings, and is configured to output a plurality of second control signals based on a plurality of currents measured at each of the output terminals. The second current control circuit is disposed between the second feedback circuit and the output terminals of the light source strings, and is configured to control a strength of each of the plurality of currents at each of the output terminals based on the plurality of second control signals.

According to an exemplary embodiment of the present invention, a backlight unit includes a driving circuit, a plurality of light source strings having a plurality of input terminals, a first feedback circuit, a first current control circuit, a second feedback circuit, and a second current control circuit. The driving circuit is configured to output a driving voltage. Each of the plurality of light source strings includes a plurality of light sources and is configured to receive the driving voltage through one of the input terminals. The first feedback circuit is disposed between the driving circuit and the input terminals of the light source strings, and is configured to output a plurality of first control signals based on a plurality of currents measured at each of the input terminals. The first current control circuit is disposed between the driving circuit and the first feedback circuit, and is configured to receive the driving voltage and control a strength of each of the plurality of first currents at each of the input terminals based on the plurality of first control signals. The second feedback circuit is connected to a plurality of output terminals of the light source strings, and is configured to output a second control signal based on a total current measured at the output terminals. The second current control circuit is disposed between the second feedback circuit and the output terminals of the light source strings, and is configured to control a strength of the total current at the output terminals based on the second control signal.

According to exemplary embodiments of the backlight unit, current control circuits and feedback circuits are disposed at both ends of the light source strings. For example, a first current control circuit and a first feedback circuit may be disposed at an input terminal of the light source string, and a second current control circuit and a second feedback circuit may be disposed at an output terminal of the light source string. As a result, malfunctioning occurring in the light source strings may be detected, and the current input to the light source strings may be controlled.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram showing a backlight unit according to an exemplary embodiment of the present invention;

FIG. 2 is a block diagram showing a detailed view of the backlight unit shown in FIG. 1;

FIG. 3 is a block diagram showing a backlight unit according to an exemplary embodiment of the present invention;

FIG. 4 is a block diagram showing a detailed view of the backlight unit shown in FIG. 3;

FIG. 5 is a block diagram showing a backlight unit according to an exemplary embodiment of the present invention; and

FIG. 6 is a block diagram showing a detailed view of the backlight unit shown in FIG. 5.

### DETAILED DESCRIPTION OF THE EXEMPLARY EMBODIMENTS

Exemplary embodiments of the present invention will be described more fully hereinafter with reference to the accompanying drawings. Like reference numerals refer to like elements throughout the accompanying drawings.

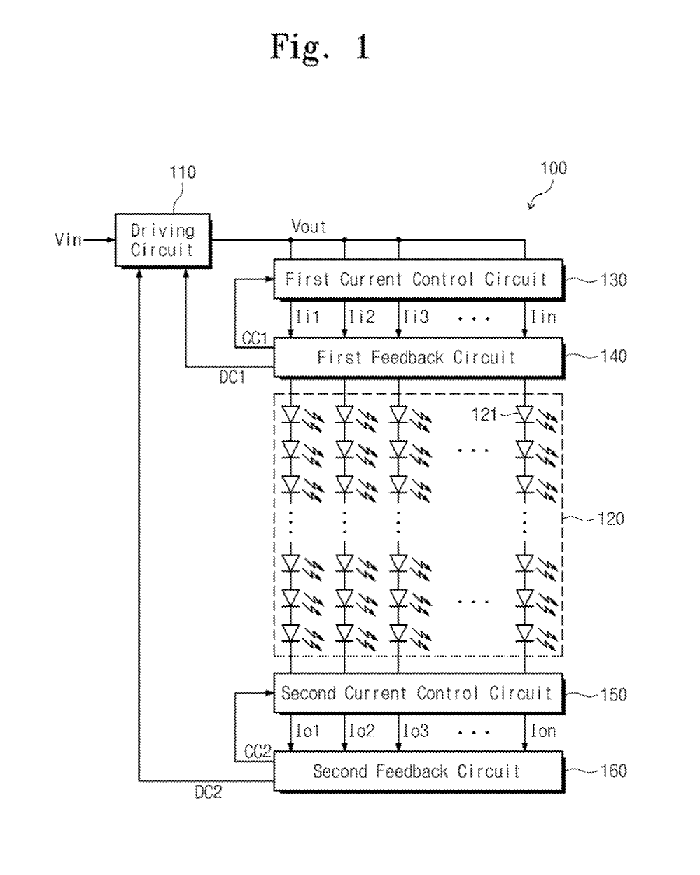

FIG. 1 is a block diagram showing a backlight unit 100 according to an exemplary embodiment of the present invention.

Referring to FIG. 1, the backlight unit 100 includes a driving circuit 110, a plurality of light source strings 120, a first feedback circuit 140, a first current control circuit 130, a second feedback circuit 160, and a second current control circuit 150.

The light source strings 120 are connected to each other in parallel. Each light source string 120 includes a plurality of light sources 121, such as, for example, light emitting diodes (LEDs) connected to each other in series. The light sources 121 may be Zener diodes, and the light source strings 120 may be connected to each other in parallel.

The driving circuit 110 receives an external input voltage Vin (e.g., 12 V) and outputs a driving voltage Vout. Although not shown in FIG. 1, the driving circuit 110 may include a DC/DC converter. The driving voltage Vout drives the light sources 121 of the light source strings 120, and has a voltage level in the range of about 20 V to about 35 V. This voltage level of the driving voltage Vout may vary depending on the number of light sources 121 connected to the light source strings 120.

The output terminal of the driving circuit 110 is electrically connected to the input terminals of the light source strings 120. Each light source string 120 receives the driving voltage Vout and supplies light generated from the light source strings 120 to a display panel (not shown).

The first feedback circuit 140 is connected to the input terminals of the light source strings 120, and measures the strength of currents Ii1 to Iin input to the input terminals of the light source strings 120. The first feedback circuit 140 outputs a first control signal CC1 to control the strength of the currents Ii1 to Iin based on the measured current value. In addition, the first feedback circuit 140 may output a first driving voltage control signal DC1 to the driving circuit 110 to control the strength of the driving voltage Vout based on the measured current value. The driving circuit 110 controls the driving voltage Vout based on the first driving voltage control signal DC1.

The first current control circuit 130 is disposed between the output terminal of the driving circuit 110 and the first feedback circuit 140, and is electrically connected to the output terminal of the driving circuit 110 and the input terminals of the light source strings 120. Thus, the first current control circuit 130 controls the strength of the currents Ii1 to Iin input to the input terminals of the light source strings 120.

The first current control circuit 130 receives the first control signal CC1 from the first feedback circuit 140 and increases the strength of the currents Ii1 to Iin input to the input terminals of the light source strings 120 when the strength of the currents Ii1 to Iin is lower than a predetermined current level. Alternatively, the first current control circuit 130 reduces the strength of the currents Ii1 to Iin input to the input terminals of the light source strings 120 when the strength of the currents Ii1 to Iin is higher than the predeteimined current level. The predeteimined current level may be theoretically or experimentally determined according to the characteristics of the light sources 121 included in the light source strings 120.

The second feedback circuit 160 is connected to the output terminals of the light source strings 120 and measures the strength of currents Io1 to Ion output to the output terminals of the light source strings 120. The second feedback circuit 160 outputs a second control signal CC2 to control the strength of the currents Io1 to Ion based on the measured current value. In addition, the second feedback circuit 160 may output a second driving voltage control signal DC2 to the driving circuit 110 to control the strength of the driving voltage Vout based on the measured current value. The driving circuit 110 controls the driving voltage Vout based on the second driving voltage control signal DC2.

The second current control circuit 150 is disposed between the output terminals of the light source strings 120 and the second feedback circuit 160, and is electrically connected to the output terminals of the light source strings 120 and the second feedback circuit 160. Thus, the second current control circuit 150 controls the strength of the currents Io1 to Ion output from the output terminals of the light source strings 120.

The second current control circuit 150 receives the second control signal CC2 from the second feedback circuit 160 and increases the strength of the currents Io1 to Ion output from the output terminals of the light source strings 120 when the strength of the currents Io1 to Ion is lower than a predetermined current level. Alternatively, the second current control circuit 150 reduces the strength of the currents Io1 to Ion output from the output terminals of the light source strings 120 when the strength of the currents Io1 to Ion is higher than the predetermined current level.

The driving circuit 110 may control the driving voltage Vout according to the first and second driving voltage control signals DC1 and DC2. The first driving voltage control signal DC1 may include the measurement result for the current input to the input terminals of the light source strings 120, and the second driving voltage control signal DC2 may include the measurement result for the current output from the output terminals of the light source strings 120. The driving circuit 110 compares the strength of the current input to the input terminals of the light source strings 120 with the strength of the current output from the output terminals of the light source strings 120 to control the driving voltage Vout. For example, if the difference between the strength of the current input to the input terminals of the light source strings 120 and the strength of the current output from the output terminals of the light source strings 120 is higher than a predetermined value, the driving circuit 110 determines that one of the light source strings 120 is subject to an electric short, and the driving circuit 110 sets the strength of the driving voltage Vout to 0 V.

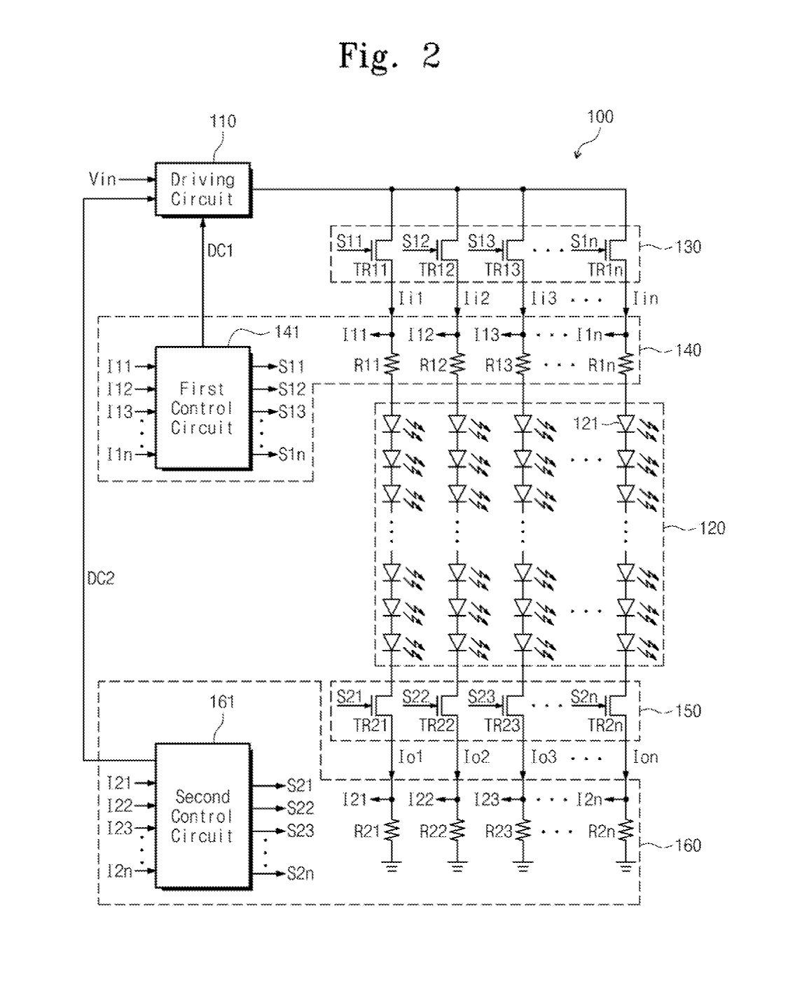

FIG. 2 is a block diagram showing a detailed view of the backlight unit 100 shown in FIG. 1. Referring to FIGS. 1 and 2, like reference numerals denote like elements, and a detailed description of such elements is omitted.

The first feedback circuit 140 includes a plurality of first resistors R11 to R1n connected between the output terminal of the driving circuit 110 and the input terminals of the light source strings 120 to measure the strength of the currents Ii1 to Iin input to the input terminals of the light source strings 120. The first feedback circuit 140 further includes a first control circuit 141 to receive current values I11 to I1n measured by the first resistors R11 to R1n. In order to reduce the power consumed by the first resistors R11 to R1n, the first resistors R11 to R1n may have resistance values lower than those of the light sources 121.

The first control circuit 141 may be an integrated circuit and may be electrically connected to the first resistors R11 to R1n and the first current control circuit 130. The first control circuit 141 receives the measured current values I11 to I1n and outputs a plurality of first control signals S11 to S1n to the first current control circuit 130. The plurality of first control signals S11 to S1n control the strength of the currents Ii1 to Iin input to the input terminals of the light source strings 120. The plurality of first control signals S11 to S1n are included in the first control signal CC1. In addition, the first control circuit 141 is connected to the driving circuit 110 and outputs the first driving voltage control signal DC1 to control the strength of the driving voltage Vout based on the measured current values I11 to I1n. The driving circuit 110 receives the first driving voltage control signal DC1 to control the driving voltage Vout.

Referring to FIG. 2, the first control circuit 141 is included in the first feedback control circuit 140. However, the present invention is not limited thereto. For example, according to an exemplary embodiment of the present invention, the first control circuit 141 may be included in the driving circuit 110.

The first current control circuit 130 includes a plurality of first current control devices. The plurality of first current control devices may be, for example, a plurality of first transistors TR11 to TR1n, however, the plurality of first current control devices is not limited thereto. The plurality of first current control devices are electrically connected to the input terminals of the light source strings 120. The first transistors TR11 to TR1n control the strength of the currents Ii1 to Iin input to the input terminals of the light source strings 120. First electrodes of the first transistors TR11 to TR1n are connected to the input terminal of the driving circuit 110, second electrodes of the first transistors TR11 to TR1n are connected to the first resistors R11 to R1n of the first feedback circuit 140, and third electrodes of the first transistors TR11 to TR1n are connected to the first control circuit 141. The first transistors TR11 to TR1n receive the plurality of first control signals S11 to S1n and control the strength of the currents Ii1 to Iin input to the input terminals of the light source strings 120.

The second feedback circuit 160 includes a plurality of second resistors R21 to R2n connected between ground and the output terminals of the light source strings 120 to measure the strength of the currents Ii1 to Iin output from the output terminals of the light source strings 120. The second feedback circuit 160 further includes a second control circuit 161 to receive current values I21 to I2n measured by the second resistors R21 to R2n. In order to reduce the power consumed by the second resistors R21 to R2n, the second resistors R21 to R2n may have resistance values lower than those of the light sources 121.

The second control circuit 161 may be an integrated circuit and may be electrically connected to the second resistors R21 to R2n and the second current control circuit 150. The second control circuit 161 receives the measured current values I21 to I2n and outputs a plurality of second control signals S21 to S2n to the second current control circuit 150. The plurality of second control signals S21 to S2n control the strength of the current Io1 to Ion output from the output terminals of the light source strings 120. The plurality of second control signals S21 to S2n are included in the second control signal CC2. In addition, the second control circuit 161 is connected to the driving circuit 110 and outputs the second driving voltage control signal DC2 to control the strength of the driving voltage Vout based on the measured current values I21 to I2n. The driving circuit 110 receives the second driving voltage control signal DC2 to control the driving voltage Vout.

Referring to FIG. 2, the second control circuit 161 is included in the second feedback control circuit 160. However, the present invention is not limited thereto. For example, according to an exemplary embodiment of the present invention, the second control circuit 161 may be included in the driving circuit 110.

The second current control circuit 150 includes a plurality of second current control devices such as, for example, a second plurality of transistors TR21 to TR2n electrically connected to the output terminals of the light source strings 120. The second transistors TR21 to TR2n control the strength of the currents Io1 to Ion output from the output terminals of the light source strings 120. First electrodes of the second transistors TR21 to TR2n are connected to the output terminals of the light source strings 120, second electrodes of the second transistors TR21 to TR2n are connected to the second resistors R21 to R2n of the second feedback circuit 160, and third electrodes of the second transistors TR21 to TR2n are connected to the second control circuit 161. The second transistors TR21 to TR2n receive the plurality of second control signals S21 to S2n and control the strength of the currents Io1 to Ion output from the output terminals of the light source strings 120.

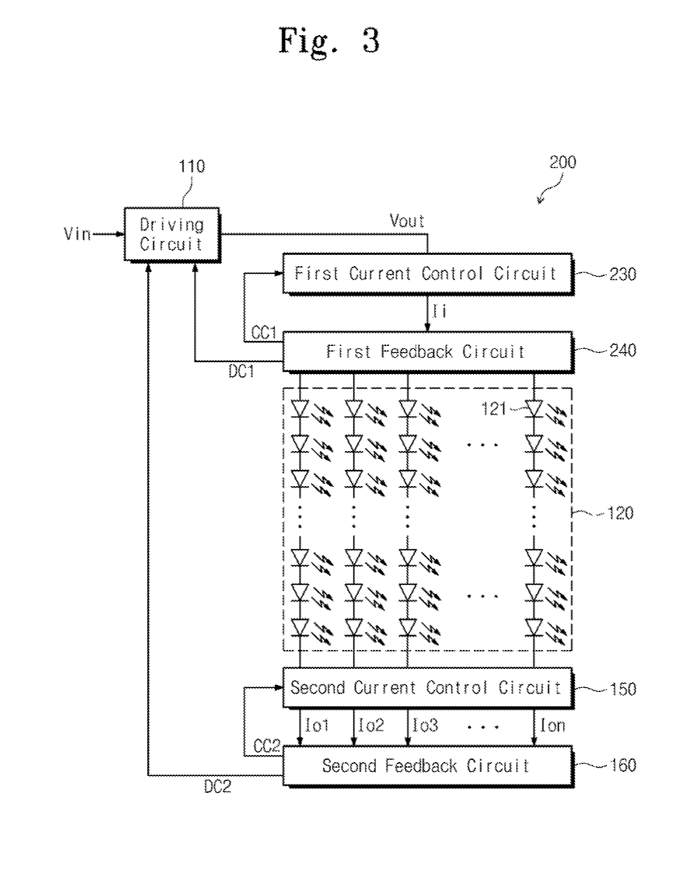

FIG. 3 is a block diagram showing a backlight unit 200 according to an exemplary embodiment of the present invention. Referring to FIGS. 1 and 3, like reference numerals denote like elements, and a detailed description of such elements is omitted.

Referring to FIG. 3, the backlight unit 200 includes a driving circuit 110, a plurality of light source strings 120, a first feedback circuit 240, a first current control circuit 130, a second feedback circuit 160 and a second current control circuit 150.

The first feedback circuit 240 is connected to the input terminals of the light source strings 120. While the first feedback circuit 140 in FIGS. 1 and 2 separately measures the strength of a plurality of currents Ii1 to Iin input to each input terminal of the light source strings 120, the first feedback circuit 240 in FIG. 3 measures the total current Ii input to all of the input terminals of the light source strings 120. The first feedback circuit 240 outputs a first control signal CC1 to control the strength of the total current Ii input to the input terminals of the light source strings 120 based on the measured current strength. In addition, the first feedback circuit 240 may output a first driving voltage control signal DC1 to the driving circuit 110 to control the strength of the driving voltage Vout based on the measured current value. The driving circuit 110 controls the driving voltage Vout based on the first driving control signal DC1.

The first current control circuit 230 is disposed between the output terminal of the driving circuit 110 and the first feedback circuit 240, and is electrically connected to the output terminal of the driving circuit 110 and the input terminals of the light source strings 120. Thus, the first current control circuit 230 controls the strength of the total current Ii input to the input terminals of the light source strings 120.

The first current control circuit 230 receives the first control signal CC1 from the first feedback circuit 240 and increases the strength of the total current Ii input to the input terminals of the light source strings 120 when the strength of the total current Ii is lower than a predetermined current level. Alternatively, the first current control circuit 230 reduces the strength of the total current Ii input to the input terminals of the light source strings 120 when the strength of the total current Ii is higher than the predetermined current level. The predetermined current level may be theoretically or experimentally determined according to the characteristics of the light sources 121 included in the light source strings 120.

The driving circuit 110 may control the driving voltage Vout according to the first and second driving voltage control signals DC1 and DC2. The first driving voltage control signal DC1 may include the measurement result for the total current Ii input to the input terminals of the light source strings 120, and the second driving voltage control signal DC2 may include the measurement result for the currents Io1 to Ion output from the output terminals of the light source strings 120. The driving circuit 110 compares a current value, which is obtained by dividing the total current Ii input to the input terminals of the light source strings 120 by the number of light source strings 120, with the strength of the currents Io1 to Ion output from the output terminals of the light source strings 120 to control the driving voltage Vout. For example, if the difference between the current value, which is obtained by dividing the total current Ii input to the input terminals of the light source strings 120 by the number of light source strings 120, and the strength of the currents Io1 to Ion output from the output terminals of the light source strings 120 is higher than a predetermined value, the driving circuit 110 determines that one of the light source strings 120 is subject to an electric short, and the driving circuit 110 sets the strength of the driving voltage Vout to 0 V.

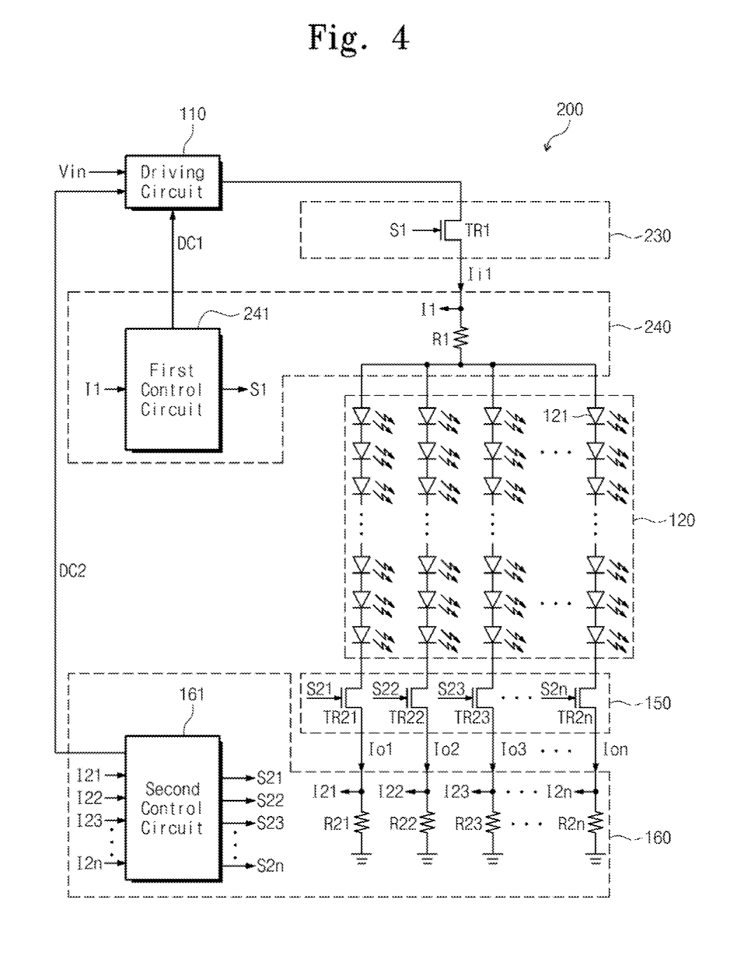

FIG. 4 is a block diagram showing a detailed view of the backlight unit 200 shown in FIG. 3. Referring to FIGS. 1 to 4, like reference numerals denote like elements, and a detailed description of such elements is omitted.

While the first feedback circuit 140 in FIGS. 1 and 2 includes a plurality of first resistors R11 to R1n connected between the output terminal of the driving circuit 110 and each of the input terminals of the light source strings 120, the first feedback circuit 240 in FIGS. 3 and 4 includes a first resistor R1 connected between the output terminal of the driving circuit 110 and the input terminals of all of the light source strings 120. Further, while the first feedback circuit 140 in FIGS. 1 and 2 measures the strength of the plurality of currents Ii1 to Iin input to each of the input terminals of the light source strings, to the first feedback circuit 240 in FIGS. 3 and 4 measures the strength of the total current Ii input to all of the input terminals of the light source strings 120. Further still, while the first control circuit 141 in FIGS. 1 and 2 receives a plurality of currents I11 to I1n measured by the plurality of first resistors R11 to R1n, the first feedback circuit 240 in FIGS. 3 and 4 includes a first control circuit 241 that receives a single current value I1 measured by the first resistor R1. In order to reduce the power consumed by the first resistor R1, the first resistor R1 may have a resistance value lower than that of the light sources 121.

The first control circuit 241 may be an integrated circuit and may be electrically connected to the first resistor R1 and the first current control circuit 230. The first control circuit 241 receives the measured current value I1 and outputs a first control signal S1 to the first current control circuit 230. The first control signal S1 is included in the first control signal CC1, and controls the strength of the total current Ii input to the input terminals of the light source strings 120. In addition, the first control circuit 241 is connected to the driving circuit 110 and outputs the first driving voltage control signal DC1 to control the strength of the driving voltage Vout based on the measured current value I1. The driving circuit 110 receives the first driving voltage control signal DC1 to control the driving voltage Vout.

Referring to FIG. 4, the first control circuit 241 is included in the first feedback control circuit 240. However, the present invention is not limited thereto. For example, according to an exemplary embodiment of the present invention, the first control circuit 241 may be included in the driving circuit 110.

While the first current control circuit 140 in FIGS. 1 and 2 includes a plurality of first current control devices, the first current control circuit 230 in FIGS. 3 and 4 includes a single first current control device. The first current control device may be, for example, a first transistor TR1, however, the first current control device is not limited thereto. The first transistor TR1 is electrically connected to the input terminals of the light source strings 120. The first transistor TR1 controls the strength of the total current Ii input to the input terminals of the light source strings 120. A first electrode of the first transistor TR1 is connected to the input terminal of the driving circuit 110, a second electrode of the first transistor TR1 is connected to the first resistor R1, and a third electrode of the first transistor TR1 is connected to the first control circuit 241. The first transistor TR1 receives the first control signal S1 and controls the strength of the total current Ii input to the input terminals of the light source strings 120.

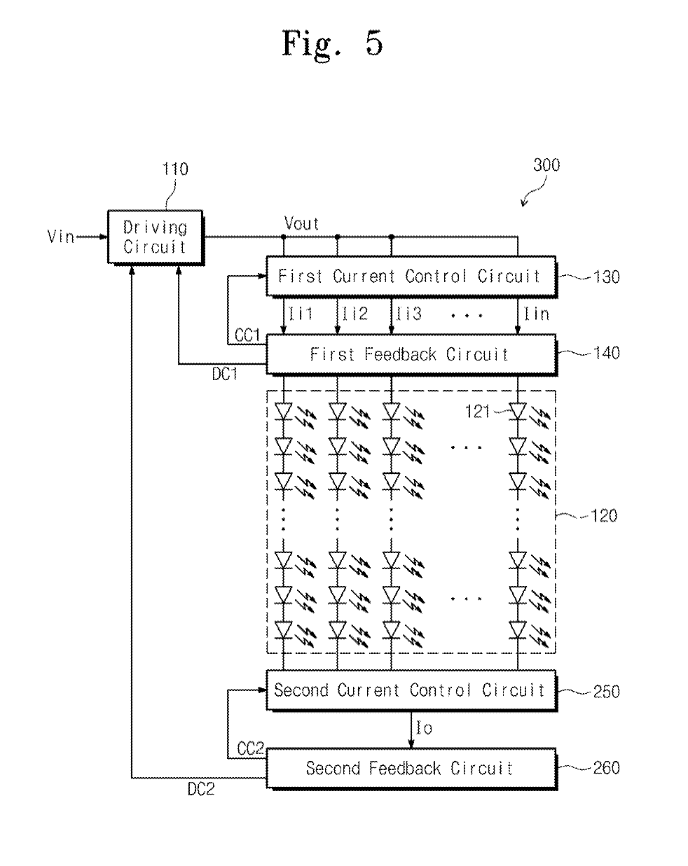

FIG. 5 is a block diagram showing a backlight unit 300 according to an exemplary embodiment of the present invention. Referring to FIGS. 1 and 5, like reference numerals denote like elements, and a detailed description of such elements is omitted.

Referring to FIG. 5, the backlight unit 300 includes a driving circuit 110, a plurality of light source strings 120, a first feedback circuit 140, a first current control circuit 130, a second feedback circuit 260 and a second current control circuit 250.

While the second feedback circuit 160 in FIGS. 1 to 4 measures the strength of the plurality of currents Io1 to Ion output from each output terminal of the light source strings 120, the second feedback circuit 260 in FIG. 5 is connected to all of the output terminals of the light source strings 120 and measures the strength of the total current Io output from all of the output terminals of the light source strings 120. The second feedback circuit 260 outputs a second control signal CC22 to control the strength of the total current Io based on the measured current value. In addition, the second feedback circuit 260 may output a second driving voltage control signal DC2 to the driving circuit 110 to control the strength of the driving voltage Vout based on the measured current value. The driving circuit 110 controls the driving voltage Vout based on the second driving voltage control signal DC2.

The second current control circuit 250 is disposed between the output terminals of the light source strings 120 and the second feedback circuit 260, and is electrically connected to the output terminals of the light source strings 120 and the second feedback circuit 260. Thus, the second current control circuit 250 controls the strength of the total current Io output from the output terminals of the light source strings 120.

The second current control circuit 250 receives the second control signal CC2 from the second feedback circuit 260 and increases the strength of the total current Io output from the output terminals of the light source strings 120 when the strength of the total current Io is lower than a predetermined current level. Alternatively, the second current control circuit 250 reduces the strength of the total current Io output from the output terminals of the light source strings 120 when the intensity of the total current Io is higher than the predetermined current level. The predetermined current level may be theoretically or experimentally determined according to the characteristics of the light sources 121 included in the light source strings 120.

The driving circuit 110 may control the driving voltage Vout according to the first and second driving voltage control signals DC1 and DC2. The first driving voltage control signal DC1 may include the measurement result for the currents I1i to I1n input to the input terminals of the light source strings 120, and the second driving voltage control signal DC2 may include the measurement result for the total current Io output from the output terminals of the light source strings 120. The driving circuit 110 compares a current value, which is obtained by dividing the total current Io output from the output terminals of the light source strings 120 by the number of light source strings 120, with the strength of the currents Ii1 to Iin input to the input terminals of the light source strings 120 to control the driving voltage Vout. For example, if the difference between the current value, which is obtained by dividing the total current Io output from the output terminals of the light source strings 120 by the number of light source strings 120, and the strength of the currents Ii1 to Iin input to the input terminals of the light source strings 120 is higher than a predetermined value, the driving circuit 110 determines that one of the light source strings 120 is subject to an electric short, and the driving circuit 110 sets the strength of the driving voltage Vout to 0 V.

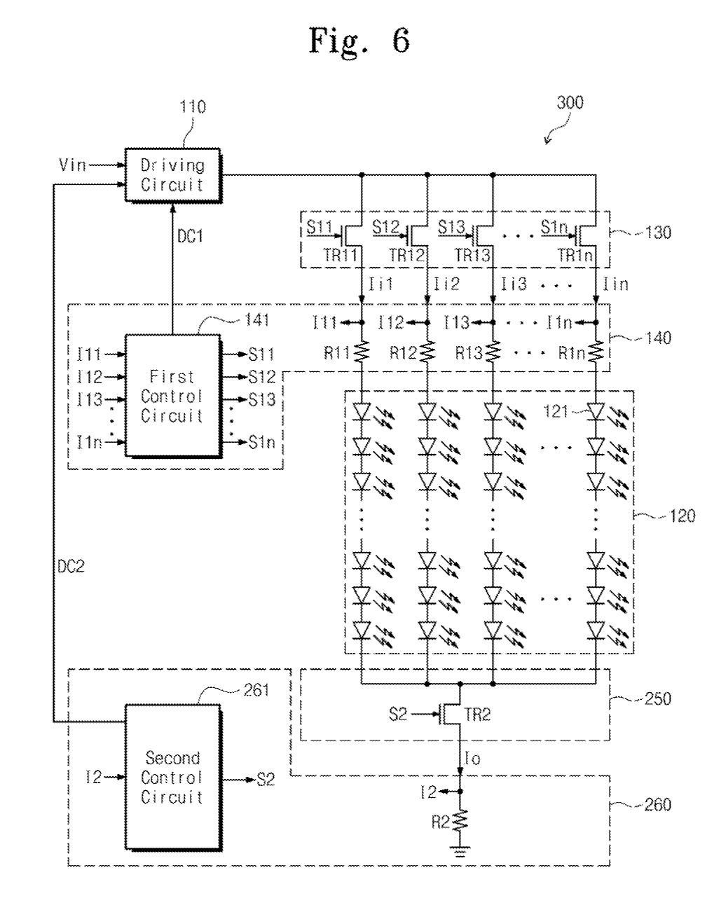

FIG. 6 is a block diagram showing a detailed view of the backlight unit 300 shown in FIG. 5. Referring to FIGS. 1 to 6, like reference numerals denote like elements, and a detailed description of such elements is omitted.

While the second feedback circuit 160 in FIGS. 1-4 includes a plurality of second resistors R21 to R2n connected between ground and the output terminals of the light source strings 120 and measures the strength of the currents Io1 to Ion output from each output terminal of the light source strings, the second feedback circuit 260 includes a single second resistor R2 connected between ground and the output terminals of the light source strings 120 and measures the strength of the total current Io output from all of the output terminals of the light source strings 120. The second feedback circuit 260 further includes a second control circuit 261 to receive a current value I2 measured by the second resistor R2. In order to reduce the power consumed by the second resistor R2, the second resistor R2 may have a resistance value lower than that of the light sources 121.

The second control circuit 261 may be an integrated circuit and may be electrically connected to the second resistor R2 and the second current control circuit 250. While the second control circuit 161 in FIGS. 1 to 4 receives the plurality of measured current values I21 to I2n measured by the plurality of second resistors R21 to R2n, the second control circuit 261 in FIGS. 5 to 6 receives the total current value I2 measured by the second resistor R2. Further, while the second control circuit 161 in FIGS. 1 to 4 outputs a plurality of second control signals S21 to S2n, the second control circuit 261 in FIG. 6 outputs a single second control signal S2 to the second current control circuit 250. The second control signal S2 controls the strength of the total current Io output from the output terminals of the light source strings 120. In addition, the second control circuit 261 is connected to the driving circuit 110 and outputs the second driving voltage control signal DC2 to control the strength of the driving voltage Vout based on the measured current value I2. The driving circuit 110 receives the second driving voltage control signal DC2 to control the driving voltage Vout.

Referring to FIG. 6, the second control circuit 261 is included in the second feedback control circuit 260. However, the present invention is not limited thereto. For example, according to an exemplary embodiment of the present invention, the second control circuit 261 may be included in the driving circuit 110.

While the second current control circuit 150 in FIGS. 1 to 4 includes a plurality of second current control devices, the second current control circuit 250 in FIGS. 5 and 6 includes a single second current control device. The second current control device may be, for example, a second transistor TR2 electrically connected to the output terminals of the light source strings 120, however, the second current control device is not limited thereto. The second transistor TR2 controls the strength of the total current Io output from the output terminals of the light source strings 120. A first electrode of the second transistor TR2 is connected to the output terminals of the light source strings 120, a second electrode of the second transistor TR2 is connected to the second resistor R2, and a third electrode of the second transistor TR2 is connected to the second control circuit 261. The second transistor TR2 receives the second control signal S2 and controls the strength of the total current Io output from the output terminals of the light source strings 120.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A backlight unit, comprising:
a driving circuit configured to output a driving voltage;
a plurality of light source strings having a plurality of input terminals, wherein each light source string comprises a plurality of light sources and is configured to receive the driving voltage through one of the input terminals;
a first feedback circuit disposed between the driving circuit and the input terminals of the light source strings, configured to output a plurality of first control signals based on a plurality of first currents measured at each of the input terminals;
a first current control circuit disposed between the driving circuit and the first feedback circuit, configured to receive the driving voltage and control a strength of each of the plurality of first currents at each of the input terminals based on the plurality of first control signals;
a second feedback circuit connected to each of a plurality of output terminals of the light source strings, configured to output a plurality of second control signals based on a plurality of second currents measured at each of the output terminals; and
a second current control circuit disposed between the second feedback circuit and the output terminals of the light source strings, configured to control a strength of each of the plurality of second currents at each of the output terminals based on the plurality of second control signals.

2. The backlight unit of claim 1, wherein the first feedback circuit is configured to measure each of the plurality of first currents at each input terminal of the light source strings and output the plurality of first control signals to the first current control circuit, and
the second feedback circuit is configured to measure each of the plurality of second currents at each output terminal of the light source strings and output the plurality of second control signals to the second current control circuit.

3. The backlight unit of claim 2, wherein the first feedback circuit comprises a first control circuit and a plurality of first resistors connected to the first control circuit and each of the input terminals of the light source strings, wherein the first control circuit is configured to output the plurality of first control signals, and
the second feedback circuit comprises a second control circuit and a plurality of second resistors connected to a ground and each of the output terminals of the light source strings, wherein the second control circuit is configured to output the plurality of second control signals.

4. The backlight unit of claim 3, wherein the first current control circuit comprises a plurality of first current control devices connected to each of the input terminals of the light source strings, wherein each of the first current control devices comprises a first electrode connected to the driving circuit and configured to receive the driving voltage, a second electrode connected to a corresponding resistor from the plurality of first resistors, and a third electrode connected to the first control circuit and configured to receive one of the plurality of first control signals.

5. The backlight unit of claim 3, wherein the second current control circuit comprises a plurality of second current control devices connected to each of the output terminals of the light source strings, wherein each of the second current control devices comprises a first electrode connected to an output terminal of a corresponding light source string from the plurality of light source strings, a second electrode connected to a corresponding resistor from the plurality of second resistors, and a third electrode connected to the second control circuit and configured to receive one of the plurality of second control signals.

6. The backlight unit of claim 1, wherein the first feedback circuit is configured to further output a first driving voltage control signal,
the second feedback circuit is configured to further output a second driving voltage control signal, and
the driving circuit is configured to control the driving voltage based on the first and second driving voltage control signals.

7. The backlight unit of claim 6, wherein the first driving voltage control signal is based on the plurality of first currents measured at each of the input terminals,
the second driving voltage control signal is based on the plurality of second currents measured at each of the output terminals, and
the driving circuit is configured to control the driving voltage based on a comparison of the strength of each of the plurality of first currents and the strength of each of the plurality of second currents.

8. A backlight unit, comprising:
a driving circuit configured to output a driving voltage;
a plurality of light source strings having a plurality of input terminals, wherein each light source string comprises a plurality of light sources and is configured to receive the driving voltage through one of the input terminals;
a first feedback circuit disposed between the driving circuit and the input terminals of the light source strings, configured to output a first control signal based on a total current measured at the input terminals;
a first current control circuit disposed between the driving circuit and the first feedback circuit, configured to receive the driving voltage and control a strength of the total current at the input terminals based on the first control signal;
a second feedback circuit connected to each of a plurality of output terminals of the light source strings, configured to output a plurality of second control signals based on a plurality of currents measured at each of the output terminals; and
a second current control circuit disposed between the second feedback circuit and the output terminals of the light source strings, configured to control a strength of each of the plurality of currents at each of the output terminals based on the plurality of second control signals.

9. The backlight unit of claim 8, wherein the first feedback circuit is configured to measure the total current at the input terminals of the light source strings and output the first control signal to the first current control circuit, and
the second feedback circuit is configured to measure each of the plurality of currents at each output terminal of the light source strings and output the plurality of second control signals to the second current control circuit.

10. The backlight unit of claim 9, wherein the first feedback circuit comprises a first control circuit and a first resistor connected to the input terminals of the light source strings, wherein the first control circuit is configured to output the first control signal, and
the second feedback circuit comprises a second control circuit and a plurality of second resistors connected to a ground and each of the output terminals of the light source strings, wherein the second control circuit is configured to output the plurality of second control signals.

11. The backlight unit of claim 10, wherein the first current control circuit comprises a first current control device connected to the input terminals of the light source strings, wherein the first current control device comprises a first electrode connected to the driving circuit and configured to receive the driving voltage, a second electrode connected to the first resistor, and a third electrode connected to the first control circuit and configured to receive the first control signal.

12. The backlight unit of claim 10, wherein the second current control circuit comprises a plurality of second current control devices connected to each of the output terminals of the light source strings, wherein each of the second current control devices comprises a first electrode connected to an output terminal of a corresponding light source string from the plurality of light source strings, a second electrode connected to a corresponding resistor from the plurality of second resistors, and a third electrode connected to the second control circuit and configured to receive one of the plurality of second control signals.

13. The backlight unit of claim 8, wherein the first feedback circuit is configured to further output a first driving voltage control signal,
the second feedback circuit is configured to further output a second driving voltage control signal, and
the driving circuit is configured to control the driving voltage based on the first and second driving voltage control signals.

14. The backlight unit of claim 13, wherein the first driving voltage control signal is based on the total current measured at the input terminals,
the second driving voltage control signal is based on the plurality of currents measured at each of the output terminals, and
the driving circuit is configured to control the driving voltage based on a comparison of a current value and the strength of each of the plurality of currents at each of the output terminals, wherein the current value is obtained by dividing the total current measured at the input terminals by a number of the light source strings.

15. A backlight unit, comprising:
a driving circuit configured to output a driving voltage;
a plurality of light source strings having a plurality of input terminals, wherein each light source string comprises a plurality of light sources and is configured to receive the driving voltage through one of the input terminals;
a first feedback circuit disposed between the driving circuit and the input terminals of the light source strings, configured to output a plurality of first control signals based on a plurality of currents measured at each of the input terminals;
a first current control circuit disposed between the driving circuit and the first feedback circuit, configured to receive the driving voltage and control a strength of each of the plurality of first currents at each of the input terminals based on the plurality of first control signals;
a second feedback circuit connected to a plurality of output terminals of the light source strings, configured to output a second control signal based on a total current measured at the output terminals; and
a second current control circuit disposed between the second feedback circuit and the output terminals of the light source strings, configured to control a strength of the total current at the output terminals based on the second control signal.

16. The backlight unit of claim 15, wherein the first feedback circuit is configured to measure each of the plurality of currents at each input terminal of the light source strings and output the plurality of first control signals to the first current control circuit, and
the second feedback circuit is configured to measure the total current at the output terminals of the light source strings and output the second control signal to the second current control circuit.

17. The backlight unit of claim 16, wherein the first feedback circuit comprises a first control circuit and a plurality of first resistors connected to the first control circuit and each of the input terminals of the light source strings, wherein the first control circuit is configured to output the plurality of first control signals, and
the second feedback circuit comprises a second control circuit and a second resistor connected to a ground and the output terminals of the light source strings, wherein the second control circuit is configured to output the second control signal.

18. The backlight unit of claim 17, wherein the first current control circuit comprises a plurality of first current control devices connected to each of the input terminals of the light source strings, wherein each of the first current control devices comprises a first electrode connected to the driving circuit and configured to receive the driving voltage, a second electrode connected to a corresponding resistor from the plurality of first resistors, and a third electrode connected to the first control circuit and configured to receive one of the plurality of first control signals.

19. The backlight unit of claim 17, wherein the second current control circuit comprises a second current control device connected to the output terminals of the light source strings, wherein the second current control device comprises a first electrode connected to the output terminals of the light source strings, a second electrode connected to the second resistor, and a third electrode connected to the second control circuit to receive the second control signal.

20. The backlight unit of claim 15, wherein the first feedback circuit is configured to further output a first driving voltage control signal,
the second feedback circuit is configured to further output a second driving voltage control signal, and
the driving circuit is configured to control the driving voltage based on the first and second driving voltage control signals.

21. The backlight unit of claim 20, wherein the first driving voltage control signal is based on the plurality of currents measured at each input terminal of the light source strings,
the second driving voltage control signal is based on the total current measured at the output terminals of the light source strings, and
the driving circuit is configured to control the driving voltage based on a comparison of the strength of each of the plurality of first currents at each of the input terminals of the light source strings with a current value, wherein the current value is obtained by dividing the total current measured at the output terminals by a number of the light source strings.
